(19) United States
(12) Patent Application Publication
(10) Pub. No.: US 2025/0182005 A1
(43) Pub. Date: Jun. 5, 2025

(54) INFORMATION PROCESSING SYSTEM, INFORMATION PROCESSING APPARATUS, AND INFORMATION PROCESSING METHOD

(71) Applicant: Sony Group Corporation, Tokyo (JP)

(72) Inventors: Fumiaki Miyahara, Tokyo (JP); Hiroshi Mori, Tokyo (JP); Kenichi Matsumoto, Kanagawa (JP)

(21) Appl. No.: 18/840,775

(22) PCT Filed: Feb. 22, 2023
(86) PCT No.: PCT/JP2023/006397

§ 371 Date: Aug. 22, 2024

(30) Foreign Application Priority Data
Mar. 7, 2022 (JP) 2022-034420

(51) Int. Cl. G06Q 10/0631

(52) U.S. Cl. CPC G06Q 10/063112

(57) ABSTRACT

An information processing system (1) according to an aspect of the present disclosure includes: a badge management unit (60) that issues a digital badge in accordance with a work skill of an operator to the operator based on work information on work performed by a target to be operated by a remote operation of the operator and prior information on the work; and a job matching unit (63) that recommends an appropriate business operator to the operator or an appropriate operator to a business operator based on badge information on a result of issuance of the digital badge and work content information on a work content presented by the business operator.

### FIELD

The present disclosure relates to an information processing system, an information processing apparatus, and an information processing method.

### BACKGROUND

In recent years, technology has been developed in which an operator remotely operates a target to be operated, such as a robot, to perform work. A business operator needs to secure an operator having a work skill (operation skill) to perform predetermined work. Several methods for evaluating a work skill of an operator who is a worker have been proposed (e.g., see Patent Literatures 1 and 2).

### CITATION LIST

### Patent Literature

Patent Literature 1: JP 2020-36909 A
Patent Literature 2: WO 2016/125915

### SUMMARY

### Technical Problem

In the above-described technology, however, merely a work skill of an operator is evaluated. Job matching (work matching) between a business operator and a worker is not necessarily performed appropriately. For example, when a business operator and a worker belong to different types of industries, there is less of a chance for the worker to apply for recruitment of the business operator, and there is also less of a chance for the business operator to adopt the worker. Thus, it is required to achieve appropriate job matching between the business operator and the worker regardless of the types of industries to which the business operator and the worker belong.

Therefore, the present disclosure proposes an information processing system, an information processing apparatus, and an information processing method capable of achieving appropriate job matching between a business operator and a worker regardless of the types of industries to which the business operator and the worker belong.

### Solution to Problem

An information processing system according to an aspect of the present disclosure includes: a badge management unit that issues a digital badge in accordance with a work skill of an operator to the operator based on work information on work performed by a target to be operated by a remote operation of the operator and prior information on the work; and a job matching unit that recommends an appropriate business operator to the operator or an appropriate operator to a business operator based on badge information on a result of issuance of the digital badge and work content information on a work content presented by the business operator.

An information processing apparatus according to an aspect of the present disclosure includes: a badge management unit that issues a digital badge in accordance with a work skill of an operator to the operator based on work information on work performed by a target to be operated by a remote operation of the operator and prior information on the work; and a job matching unit that recommends an appropriate business operator to the operator or an appropriate operator to a business operator based on badge information on a result of issuance of the digital badge and work content information on a work content presented by the business operator.

An information processing method according to an aspect of the present disclosure includes: issuing a digital badge in accordance with a work skill of an operator to the operator based on work information on work performed by a target to be operated by a remote operation of the operator and prior information on the work; and recommending an appropriate business operator to the operator or an appropriate operator to a business operator based on badge information on a result of issuance of the digital badge and work content information on a work content presented by the business operator.

### BRIEF DESCRIPTION OF DRAWINGS

FIG. 1 illustrates one example of a schematic configuration of an information processing system according to an embodiment of the present disclosure.

FIG. 2 illustrates one example of job matching according to the embodiment of the present disclosure.

FIG. 3 illustrates one example of a general-purpose skill according to the embodiment of the present disclosure.

FIG. 4 illustrates one example of the general-purpose skill according to the embodiment of the present disclosure.

FIG. 5 is a flowchart illustrating one example of a flow of job matching processing in different types of industries according to the embodiment of the present disclosure.

FIG. 6 illustrates one example of job matching in different types of industries according to the embodiment of the present disclosure.

FIG. 7 illustrates one example of the job matching in different types of industries according to the embodiment of the present disclosure.

FIG. 8 illustrates one example of the job matching in different types of industries according to the embodiment of the present disclosure.

FIG. 9 is a flowchart illustrating one example of a flow of digital badge issuing processing according to the embodiment of the present disclosure.

FIG. 10 is a flowchart illustrating one example of a flow of job matching processing from the viewpoint of a business operator according to the embodiment of the present disclosure.

FIG. 11 is a flowchart illustrating one example of a flow of job matching processing from the viewpoint of an operator according to the embodiment of the present disclosure.

FIG. 12 illustrates one example of a schematic configuration of hardware according to the embodiment of the present disclosure.

### DESCRIPTION OF EMBODIMENTS

Embodiments of the present disclosure will be described in detail below with reference to the drawings. Note that a system, an apparatus, a method, and the like according to the present disclosure are not limited by the embodiments. Furthermore, in each of the following embodiments, basically, the same reference signs are attached to the same parts, and duplicate description is omitted.

One or a plurality of embodiments (including examples and variations) to be described below can be implemented independently. In contrast, at least a part of the plurality of embodiments to be described below may be appropriately combined and implemented with at least a part of other embodiments. The plurality of embodiments can include different novel features. Therefore, the plurality of embodiments may contribute to solving different objects or problems, and may exhibit different effects.

The present disclosure will be described in the following item order.
1. Embodiment
1-1. Configuration Example of Information Processing System
1-2. One Example of Job Matching
1-3. One Example of General-Purpose Skill
1-4. One Example of Job Matching in Different Types of Industries
1-5. One Example of Digital Badge Issuing Processing
1-6. One Example of Job Matching Processing from Viewpoint of Business Operator
1-7. One Example of Job Matching Processing from Viewpoint of Operator
1-8. Actions/Effects
2. Other Embodiments
3. Configuration Example of Hardware
4. Appendix

### 1. Embodiment

### <1-1. Configuration Example of Information Processing System>

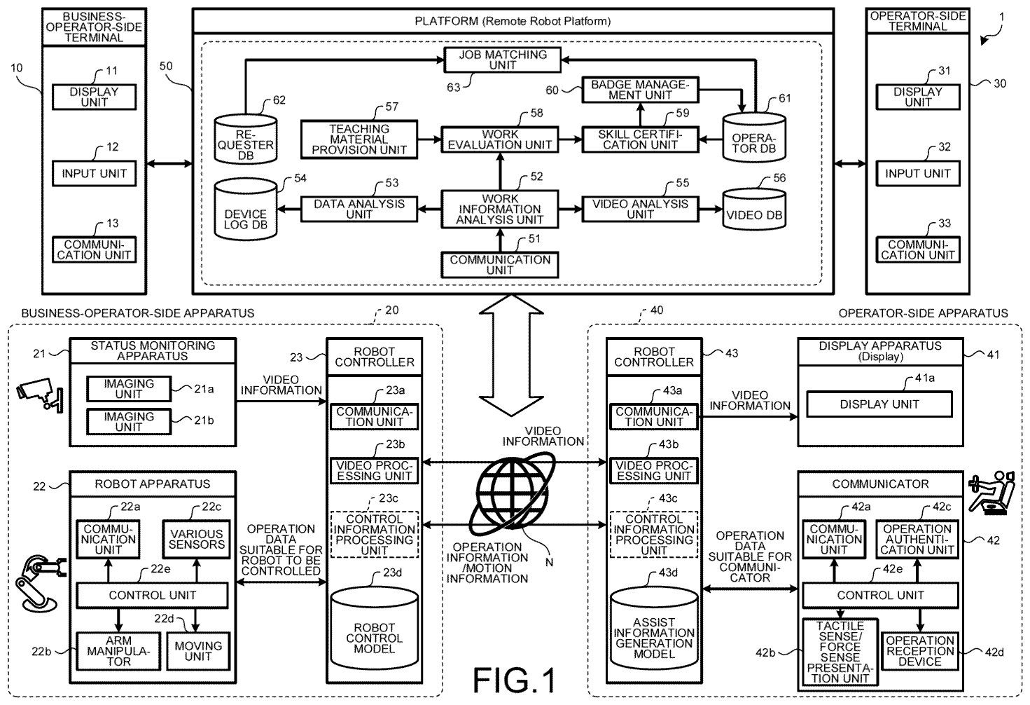

A configuration example of an information processing system 1 according to the embodiment will be described with reference to FIG. 1. FIG. 1 illustrates one example of a schematic configuration of the information processing system 1 according to the embodiment. The information processing system 1 according to the embodiment provides a remote robot control system, a workflow management system, and a job matching system.

As illustrated in FIG. 1, the information processing system 1 according to the embodiment includes a business-operator-side terminal 10, a business-operator-side apparatus 20, an operator-side terminal 30, an operator-side apparatus 40, and a remote robot platform (platform) 50. These units 10, 20, 30, 40, and 50 can communicate (transmit and receive) various pieces of information via both or one of wireless and wired networks N. Each of the units 10, 20, 30, 40, and 50 functions as an information processing apparatus. Various pieces of information are desirably transmitted and received in an encrypted manner, but this is not a limitation. Note that FIG. 1 merely illustrates an example. The units 10, 20, 30, 40, and 50 are not required to be one apparatus, but may be distributed. Furthermore, the number of the units 10, 20, 30, 40, and 50, the networks N, and the like is not limited.

A network N is a communication network such as a local area network (LAN), a wide area network (WAN), a cellular network, a fixed telephone network, a regional Internet protocol (IP) network, and the Internet. The network N may include a wired network or a wireless network. Furthermore, the network N may include a core network. The core network includes, for example, an evolved packet core (EPC) and a 5G core network (5GC). Furthermore, the network N may include a data network other than the core network. For example, the data network may be a service network of a telecommunications carrier, for example, an IP multimedia subsystem (IMS) network. Furthermore, the data network may be a private network, such as an intra-company network. Furthermore, the network N may include a software defined network (SDN).

Furthermore, a communication apparatus used for communication may be connected to the network N by using radio access technology (RAT) such as long term evolution (LTE), new radio (NR), Wi-Fi (registered trademark), and Bluetooth (registered trademark). In this case, the communications apparatus may be able to use different types of radio access technology. For example, the communication apparatus may be able to use NR and Wi-Fi. Furthermore, the communication apparatus may be able to use different types of cellular communication technology (e.g., LTE and NR). LTE and the NR are types of the cellular communication technology, and enable mobile communication of a communication apparatus by arranging a plurality of areas covered by a base station in a cell shape.

### (Business-Operator-Side Terminal)

The business-operator-side terminal 10 is used by a business operator (e.g., requester and supervisor). The business-operator-side terminal 10 exchanges various pieces of information such as business-operator information and operator information with the platform 50. The business-operator information includes, for example, various pieces of information such as a business-operator identification (ID) and recruitment information. Furthermore, the operator information includes various pieces of information such as an operator ID and a skill level of an operator. The business-operator-side terminal 10 includes, for example, a personal computer (e.g., laptop computer and desktop computer), a smart device (e.g., smartphone and tablet), a personal digital assistant (PDA), and a mobile phone.

The business-operator-side terminal 10 as described above includes a display unit 11, an input unit 12, and a communication unit 13. Note that FIG. 1 illustrates a functional configuration, and a hardware configuration may be different from the functional configuration. Furthermore, the functions of the business-operator-side terminal 10 may be distributed and implemented in a plurality of physically separated configurations.

The display unit 11 is a display apparatus that displays various pieces of information. The display unit 11 includes, for example, a liquid crystal display and an organic electro luminescence (EL) display. Note that, when a touch panel is adopted as the business-operator-side terminal 10, the display unit 11 may be an apparatus integrated with an operation apparatus of the input unit 12. The display unit 11 displays various pieces of information, and provides the information to the business operator.

The input unit 12 is an input apparatus that receives various inputs from the outside. The input unit 12 includes an operation apparatus that receives an input operation of the business operator. The operation apparatus is an apparatus for a user to perform various operations, such as a keyboard, a mouse, and an operation key. Note that, when a touch panel is adopted as the business-operator-side terminal 10, the operation apparatus also includes the touch panel. In this case, the business operator performs various operations by touching a screen with his/her finger or a stylus. Furthermore, the operation apparatus may be a voice input apparatus (e.g., microphone) that receives an input operation through voice of the business operator.

The communication unit 13 is a communication interface for communicating with another apparatus. The communication unit 13 communicates with the platform 50, for example. The communication unit 13 includes, for example, various communication interfaces such as a wired interface and a wireless interface.

### (Business-Operator-Side Apparatus)

The business-operator-side apparatus 20 includes a status monitoring apparatus 21, a robot apparatus 22, and a robot controller 23. Note that FIG. 1 illustrates a functional configuration, and a hardware configuration may be different from the functional configuration. Furthermore, the functions of the business-operator-side apparatus 20 may be distributed and implemented in a plurality of physically separated configurations.

The status monitoring apparatus 21 includes a plurality of imaging units 21a and 21b. Each of the imaging units 21a and 21b is a camera that captures a video and acquires an image. For example, each of the imaging units 21a and 21b captures a bird's-eye video and a hand-side video (plurality of bird's-eye images and plurality of hand-side images). In one example, the imaging unit 21a captures a bird's-eye video, and the imaging unit 21b captures a hand-side video. Various cameras including an imaging element such as a charge-coupled device (CCD) and a complementary metal-oxide semiconductor (CMOS) can be used as the imaging units 21a and 21b.

The robot apparatus 22 includes a communication unit 22a, an arm manipulator 22b, various sensors 22c, a moving unit 22d, and a control unit 22e. The robot apparatus 22 is to be remotely operated.

The communication unit 22a is a communication interface for communicating with another apparatus. The communication unit 22a communicates with, for example, the robot controller 23. The communication unit 22a includes various communication interfaces such as a wired interface and a wireless interface.

The arm manipulator 22b is, for example, a robot arm having multiple joints (multiple shafts). The arm manipulator 22b enables work in three-dimensional space. Note that the arm manipulator 22b may include a robot hand, which is one example of an end effector. There are many types of robot hands, and the robot hands differ depending on the business contents (e.g., work contents) of the business operator.

The various sensors 22c belong to a sensor group that detects the state of the arm manipulator 22b. The various sensors 22c include various sensors that detect, for example, a torque, an angle, an angular velocity, and the like of a joint portion of an arm, a position and a speed of a distal end of the arm, a tactile sense, and a force sense. For example, the angle of the joint portion is acquired from an encoder in an actuator provided in the joint portion.

The moving unit 22d moves the arm manipulator 22b. For example, the moving unit 22d moves the arm manipulator 22b itself in a horizontal plane or a vertical plane. The moving unit 22d may move the arm manipulator 22b in a direction of one axis (X axis), two axes (XY axes), and three axes (XYZ axes). When the arm manipulator 22b does not need to be moved, the moving unit 22d is unnecessary.

The control unit 22e is a controller that controls each unit of the robot apparatus 22. The control unit 22e controls the arm manipulator 22b based on, for example, operation information transmitted from the robot controller 23. The control unit 22e is implemented by a processor such as a central processing unit (CPU) and a micro processing unit (MPU). Note that the control unit 22e may be implemented by an integrated circuit such as an application specific integrated circuit (ASIC) and a field programmable gate array (FPGA). All of the CPU, the MPU, the ASIC, and the FPGA can be regarded as controllers.

The robot controller 23 includes a communication unit 23a, a video processing unit 23b, a control information processing unit 23c, and a robot control model 23d.

The communication unit 23a is a communication interface for communicating with another apparatus. The communication unit 23a communicates with, for example, the status monitoring apparatus 21, the robot apparatus 22, the operator-side apparatus 40, and the platform 50. The communication unit 23a includes, for example, various communication interfaces such as a wired interface and a wireless interface.

The video processing unit 23b processes video information transmitted from the status monitoring apparatus 21, and transmits the video information to the communication unit 23a. For example, the video processing unit 23b encodes (e.g., encrypts or compresses) the video information transmitted from the status monitoring apparatus 21, and transmits the encoded video information to the communication unit 23a. The communication unit 23a transmits the video information to the operator-side apparatus 40, the platform 50, and the like.

The control information processing unit 23c generates operation information suitable for the robot apparatus 22 based on the operation information transmitted from the operator-side apparatus 40 or the operation information transmitted from the operator-side apparatus 40 and the robot control model 23d based on the robot control model 23d, and transmits the generated operation information to the robot apparatus 22. Furthermore, the control information processing unit 23c encodes (e.g., encrypts or compresses) motion information obtained from the robot apparatus 22, as necessary, and transmits the encoded motion information to the communication unit 23a. The communication unit 23a transmits the motion information to the operator-side apparatus 40, the platform 50, and the like. Furthermore, the control information processing unit 23c decodes the operation information transmitted from the operator-side apparatus 40, as necessary.

Note that the robot controller 23 can also be implemented in a form in which a software development kit (SDK) is incorporated in an existing robot control PC. In this case, executing a disclosed application programming interface (API) enables communication between the outside and the business-operator-side apparatus 20. A developer can implement a new function in an application with less effort by using the SDK,

The robot control model 23d is a control information model for automatically controlling the robot apparatus 22. The robot control model 23d is stored in a storage apparatus such as a storage, and is read and used by the control information processing unit 23c.

Note that, although, in an example of FIG. 1, the business-operator-side apparatus 20 includes two imaging units (imaging units 21a and 21b) and one robot apparatus 22, the number thereof is merely an example. In practice, the imaging units 21a and 21b and the robot apparatus 22 are provided in accordance with the number of work processes, work contents, and the like, so that a large number of imaging units 21a and 21b and robot apparatuses 22 are commonly provided.

### (Operator-Side Terminal)

The operator-side terminal 30 is used by an operator. The operator-side terminal 30 exchanges various pieces of information such as business-operator information and operator information with the platform 50. For example, similarly to the business-operator-side terminal 10, the operator-side terminal 30 includes a personal computer (e.g., laptop computer and desktop computer), a smart device (e.g., smartphone and tablet), a PDA, and a mobile phone.

Similarly to the business-operator-side terminal 10, the operator-side terminal 30 as described above includes a display unit 31, an input unit 32, and a communication unit 33. Note that FIG. 1 illustrates a functional configuration, and a hardware configuration may be different from the functional configuration. Furthermore, the functions of the operator-side terminal 30 may be distributed and implemented in a plurality of physically separated configurations.

The display unit 31 is a display apparatus that displays various pieces of information. The display unit 31 is, for example, a liquid crystal display and an organic EL display. Note that, when a touch panel is adopted as the operator-side terminal 30, the display unit 31 may be an apparatus integrated with an operation apparatus of the input unit 32. The display unit 31 displays various pieces of information, and provides the information to the operator.

The input unit 32 is an input apparatus that receives various inputs from the outside. The input unit 32 includes an operation apparatus that receives an input operation of the operator. The operation apparatus is an apparatus for a user to perform various operations, such as a keyboard, a mouse, and an operation key. Note that, when a touch panel is adopted as the operator-side terminal 30, the operation apparatus also includes the touch panel. In this case, the operator performs various operations by touching a screen with his/her finger or a stylus. Furthermore, the operation apparatus may be a voice input apparatus (e.g., microphone) that receives an input operation through voice of the operator.

The communication unit 33 is a communication interface for communicating with another apparatus. The communication unit 33 communicates with the platform 50, for example. The communication unit 33 includes, for example, various communication interfaces such as a wired interface and a wireless interface.

### (Operator-Side Apparatus)

The operator-side apparatus 40 includes a display apparatus 41, a communicator 42, and a robot controller 43. Note that FIG. 1 illustrates a functional configuration, and a hardware configuration may be different from the functional configuration. Furthermore, the functions of the operator-side apparatus 40 may be distributed and implemented in a plurality of physically separated configurations.

The display apparatus 41 includes a display unit 41a. The display unit 41a is, for example, a liquid crystal display and an organic EL display. Although, in the example of FIG. 1, one display unit 41a is provided, this is not a limitation. A plurality of display units 41a may be provided. The display unit 41a displays various pieces of information including video information, and provides the information to the operator.

Note that the type of the display unit 41a is not particularly limited. For example, the display unit 41a may be an xR device such as an augmented reality (AR) device, a virtual reality (VR) device, and a mixed reality (MR) device. Here, the xR device may be a spectacle-type device (e.g., AR/MR/VR glasses) or a head-mounted or goggle-type device (e.g., AR/MR/VR headsets and AR/MR/VR goggles). These xR devices may display a video only to one eye, or may display a video to both eyes.

The communicator 42 includes a communication unit 42a, a tactile sense/force sense presentation unit 42b, an operation authentication unit 42c, an operation reception device 42d, and a control unit 42e. The communicator 42 is an apparatus used by the operator for a remote operation.

The communication unit 42a is a communication interface for communicating with another apparatus. The communication unit 42a communicates with, for example, the robot controller 43. The communication unit 42a includes, for example, various communication interfaces such as a wired interface and a wireless interface.

The tactile sense/force sense presentation unit 42b is an apparatus that presents a tactile sense and a force sense to the operator. This enables the operator to remotely operate the robot apparatus 22 while obtaining a tactile sense such as hardness/softness of an object and a force sense such as a force level in a case where the object is handled.

The operation authentication unit 42c authenticates an input operation of the operator to the operation reception device 42d. For example, the operation authentication unit 42c authenticates only an input operation of the operator permitted to perform an operation. Various authentication methods such as operator identification (ID) authentication, password authentication, and face authentication can be used as the authentication method.

The operation reception device 42d is an input unit that receives an input operation of the operator. The operation reception device 42d is an apparatus for the user to perform various operations, such as a handle, a joystick, a button, a keyboard, a mouse, and an operation key. The operator operates the operation reception device 42d, and remotely performs work with the robot apparatus 22. In this case, the operator operates the operation reception device 42d while looking at the display unit 41a to recognize video information.

The control unit 42e is a controller that controls each unit of the communicator 42. The control unit 42e is implemented by a processor such as a CPU and an MPU. Note that the control unit 42e may be implemented by an integrated circuit such as an ASIC and an FPGA. All of the CPU, the MPU, the ASIC, and the FPGA can be regarded as controllers.

The robot controller 43 includes a communication unit 43a, a video processing unit 43b, a control information processing unit 43c, and an assist information generation model 43d.

The communication unit 43a is a communication interface for communicating with another apparatus. The communication unit 43a communicates with, for example, the display apparatus 41, the communicator 42, the business-operator-side apparatus 20, and the platform 50. The communication unit 43a includes, for example, various communication interfaces such as a wired interface and a wireless interface.

The video processing unit 43b processes video information transmitted from the business-operator-side apparatus 20, and transmits the video information to the communication unit 43a. For example, the video processing unit 43b decodes the video information transmitted from the business-operator-side apparatus 20, as necessary, and transmits the decoded video information to the communication unit 43a. The communication unit 43a transmits the video information to the display apparatus 41. The display unit 41a displays the video information.

The control information processing unit 43c generates operation information suitable for the communicator 42 based on the assist information generation model 43d, and transmits the generated operation information to the communicator 42. Furthermore, the control information processing unit 43c encodes (e.g., encrypts or compresses) the operation information transmitted from the communicator 42, as necessary, and transmits the encoded operation information to the communication unit 43a. The communication unit 43a transmits the operation information to the business-operator-side apparatus 20, the platform 50, and the like.

The assist information generation model 43d is a model for generating assist information. The assist information is used for assisting an operation of the operator, for example. The assist information generation model 43d is stored in a storage apparatus such as a storage, and is read and used by the control information processing unit 43c.

### (Platform)

The platform 50 includes a communication unit 51, a work information analysis unit 52, a data analysis unit 53, a device log database (DB) 54, a video analysis unit 55, a video DB 56, a teaching material provision unit 57, a work evaluation unit 58, a skill certification unit 59, a badge management unit 60, an operator DB 61, a requester DB 62, and a job matching unit 63.

Note that the platform 50 is a server that manages various pieces of information, for example. For example, the platform 50 manages various pieces of information on the business-operator-side terminal 10, the business-operator-side apparatus 20, the operator-side terminal 30, and the operator-side apparatus 40, and relays exchange of the various pieces of information. For example, a cloud server, a PC server, a midrange server, and a mainframe server can be used as the server. Furthermore, the functions of the server may be configured by, for example, a plurality of servers, or may be implemented by being divided into a plurality of physically separated configurations.

The communication unit 51 is a communication interface for communicating with another apparatus. The communication unit 51 communicates with, for example, the business-operator-side terminal 10, the business-operator-side apparatus 20, the operator-side terminal 30, and the operator-side apparatus 40. The communication unit 51 includes, for example, various communication interfaces such as a wired interface and a wireless interface.

The work information analysis unit 52 analyzes the encoded work information (e.g., operation information/motion information and video information) transmitted from the communication unit 51. For example, the work information analysis unit 52 decodes the work information transmitted from the communication unit 51, as necessary. The work information analysis unit 52 transmits the decoded operation information/motion information to the data analysis unit 53, and transmits the decoded video information to the video analysis unit 55. Furthermore, the work information analysis unit 52 transmits the decoded work information to the work evaluation unit 58. Note that the work information is associated with identification information of the operator (e.g., operator ID). The work information may include identification information of the robot apparatus 22 (e.g., robot ID), as necessary.

The data analysis unit 53 analyzes the operation information/motion information transmitted from the work information analysis unit 52, and transmits analysis result information on the analysis result to the device log DB 54 together with the operation information/motion information. For example, the data analysis unit 53 analyzes whether or not the operation information/motion information is appropriate by error detection, a correction code, and the like. Furthermore, the data analysis unit 53 analyzes the operation information/motion information by machine learning (e.g., deep learning) or the like. The analysis result information is associated with an operator ID, and is associated with target operation information/motion information.

The device log DB 54 stores the analysis result information and the operation information/motion information transmitted from the data analysis unit 53 as log information. The log information is associated with an operator ID. The log information is read and used, as necessary.

The video analysis unit 55 analyzes the video information transmitted from the work information analysis unit 52, and transmits analysis result information on the analysis result to the video DB 56 together with the video information. For example, the video analysis unit 55 analyzes whether or not the video information is appropriate by error detection, a correction code, and the like. Furthermore, for example, the video analysis unit 55 has a target determination function using image recognition technology, analyzes video information by the target determination function (image recognition processing), and determines a desired object from the video information. The analysis result information is associated with an operator ID, and is associated with target video information. Note that the target determination function may be implemented by machine learning (e.g., deep learning) and the like.

The video DB 56 stores the analysis result information and the video information transmitted from the video analysis unit 55. The analysis result information and the video information are associated with the operator ID. The analysis result information and the video information are read and used, as necessary.

The teaching material provision unit 57 transmits teaching material information on a teaching material to the work evaluation unit 58. The teaching material information includes, for example, non-defective product information on a non-defective product and motion information on a motion path of the robot apparatus 22 to be a work model, and the like. The non-defective product information is, for example, range information on a specified range to be a work target. Examples of the non-defective product information include information in which the specified range is specified by a numerical value of plus or minus to a target value. Furthermore, in the motion information, the motion path is specified based on coordinates of three-dimensional space, for example. Note that the teaching material information may be obtained by machine learning, simulation, and the like. The teaching material information corresponds to prior information.

The work evaluation unit 58 evaluates a work skill (operation skill) of the operator to the robot apparatus 22 to be remotely operated based on the teaching material information transmitted from the teaching material provision unit 57, the work information (e.g., operation information/motion information and video information) transmitted from the work information analysis unit 52, and the like, and transmits evaluation result information on the evaluation result to the skill certification unit 59. The evaluation result information is associated with the operator ID. For example, the work evaluation unit 58 compares the teaching material information with the work information to determine whether the work is good or bad (e.g., work quality), and evaluates the work skill. In the evaluation of the work skill, for example, a skill certification value for certifying the work skill of the operator is determined.

The skill certification unit 59 certifies a skill of the operator identified by the operator ID based on the evaluation result information transmitted from the work evaluation unit 58, the operator information from the operator DB 61, and the like, and transmits certification result information on the certification result to the badge management unit 60. The certification result information is associated with the operator ID.

The badge management unit 60 issues a digital badge (certification digital badge) to the operator identified by the operator ID based on the certification result information transmitted from the skill certification unit 59, and transmits badge information on a result of the issuance of the digital badge to the operator DB 61. The badge information is included in the operator information, and is associated with the operator ID. In the issuance of a digital badge, for example, the badge is issued in accordance with a skill certification value. In one example, when a skill certification value of the operator is a predetermined threshold or more, a digital badge is given to the operator. The digital badge is issued/operated without being tampered by, for example, blockchain technology.

The operator DB 61 stores operator information on the operator. The operator information includes, for example, an operator ID, profile information on the operator, work history information (operation history information) on the operator, and work environment information (operation environment information) on the operator. Each of these pieces of information is associated with the operator ID. Note that the profile information includes the badge information transmitted from the badge management unit 60. The operator information is read and used, as necessary. For example, the badge information is read from the operator DB 61 based on the operator ID and updated each time the badge management unit 60 issues a digital badge to the operator to whom the badge is to be issued.

The profile information relates to a profile of the operator. The profile information includes, for example, work evaluation result information on a result of evaluation of work performed by an operation of the operator. The work evaluation result information includes, for example, evaluation information such as comprehensive evaluation on a system or in the outside and evaluation for each work. The evaluation information includes, for example, badge information. Examples of an operator skill to be evaluated include a technical skill, a knowledge skill, a general-purpose skill, and characteristics of the operator. Furthermore, the profile information includes history information on, for example, one or both of a history of participations in a course of the operator on a system or in the outside and a history of evaluations of work performed by an operation of the operator. The history information includes information such as a history of participations in a course of E-learning and a history of acquisitions of a digital badge.

The work history information includes, for example, career information on the career of the operator and work environment history information on a work environment history of the operator. The career information includes, for example, career information and conflict information on a system. Furthermore, the work environment history information includes information on a degree of stability of past communication and security literacy, for example.

The work environment information includes, for example, communication status monitoring information on the communication status of a work environment and access source monitoring information on the status of the work environment. The communication status monitoring information includes, for example, information such as a communication status. Furthermore, the access source monitoring information includes, for example, information such as whether or not a work environment is in a conspicuous place.

The requester DB 62 stores requester information on a requester, that is, business-operator information. The business-operator information includes, for example, business operator identification information (e.g., business operator ID) and business operator recruitment information. The business-operator information is associated with a business operator ID. The business-operator information is read and used, as necessary. The recruitment information includes various pieces of information on recruitment, such as entry conditions, work contents, and a salary.

The job matching unit 63 matches an operator (worker) with a business operator based on operator information stored in the operator DB 61 and business-operator information stored in the requester DB 62. Examples of the business operator include a metalworking industry, a pharmaceutical manufacturing industry, and a distribution industry (example of attribute of business operator). Furthermore, examples of the operator include an operator engaged in the distribution industry, an operator engaged in a metal industry, and a skilled operator (example of attribute of operator). Examples of the skilled operator (skilled worker) include an operator engaged in a plurality of types of industries. The skilled operator is determined by years of experience, the number of badges, skills, and the like. For example, an operator having years of experience, the number of badges, the number of skills, and a skill value higher than a predetermined value is defined as a skilled operator. Note that examples of the work include various kinds of work such as various kinds of manufacturing, cutting, grinding, casting, forging, welding, and soldering.

Here, the operator information includes, for example, badge information indicating the number of badges corresponding to the operator ID. For example, a digital badge is issued to the operator for each type of industry in which the operator is engaged. One digital badge is issued to an operator who has been engaged in one type of industry and certified to be skilled in the type of industry. The digital badge proves skill certification in the type of industry in which the operator has been engaged. Furthermore, two digital badges are issued to an operator who has been engaged in two types of industries and certified to be skilled in the types of industries. The digital badges prove skill certification in each of the types of industries in which the operator has been engaged.

In matching, the job matching unit 63 selects an optimal business operator from a plurality of pieces of business-operator information and introduces the business operator to the operator based on a single digital badge or a combination of digital badges. For example, each business operator sets a condition of a digital badge corresponding to a necessary skill, a desired skill, a skill value for each skill, and the like. The job matching unit 63 selects a business operator (e.g., business operator most suitable for operator), who has set a condition of a digital badge held by an operator, from a plurality of business operators, and introduces the business operator as an optimal business operator for the operator holding a single digital badge or a plurality of digital badges. An operator can achieve work matching in a new form. For example, the operator can utilize a skill which he/she has achieved in metal grinding work also in a pharmaceutical manufacturing industry (site of manufacturing of cell pharmaceutical products) different from the metalworking industry. The operator can be engaged in an industry of a type which the operator has not found successfully.

Furthermore, the job matching unit 63 introduces an optimal operator among a plurality of operators to a business operator based on a single digital badge or a combination of digital badges. The job matching unit 63 selects an operator (e.g., operator having number of digital badges and skill value exceeding predetermined value) from a plurality of operators having a single digital badge or a plurality of digital badges, and introduces the operator to the business operator as an optimal operator. The business operator can reduce adoption mismatch, and can achieve utilization for training a successor. For example, the operator introduction system can be utilized for determining which operator is optimal to succeed to a skill of a skilled operator from the relation between held digital badges.

Note that, although the job matching unit 63 introduces an optimal operator to a business operator and introduces an optimal business operator to an operator, this is not a limitation. The job matching unit 63 may introduce an appropriate single business operator or a plurality of appropriate business operators to an operator, or may introduce an appropriate single operator or a plurality of appropriate operators to a business operator. The appropriate operator is, for example, an operator holding a single digital badge or a plurality of digital badges. The optimal operator has an operator who has the number of digital badges or a skill value exceeding a predetermined value among appropriate operators. The predetermined number is preset by, for example, a business operator or the like, but may be appropriately changed. The business operator can change a predetermined value by performing an input operation on the input unit 12 of a business-operator terminal 10, for example.

### <1-2. One Example of Job Matching>

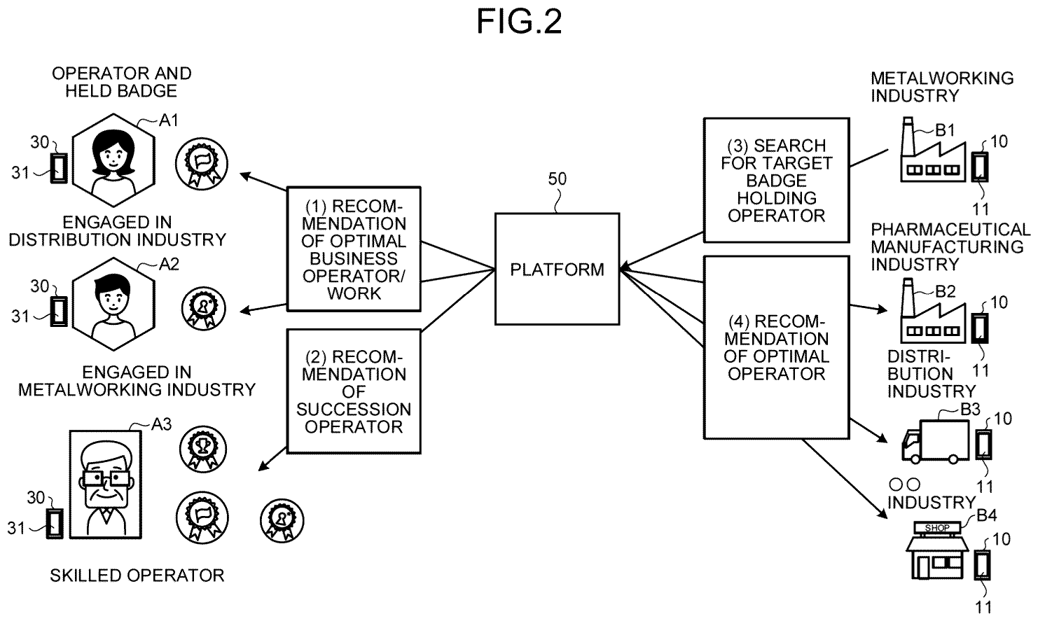

One example of job matching according to the embodiment will be described with reference to FIG. 2. FIG. 2 illustrates one example of job matching according to the embodiment.

As illustrated in FIG. 2, the job matching unit 63 of the platform 50 performs (1) recommendation of an optimal business operator and work and (2) recommendation of a succession operator for the operator based on, for example, operator information and business-operator information. Furthermore, the job matching unit 63 performs (3) search for a target badge holding operator or (4) recommendation of an optimal operator for the business operator based on operator information and business-operator information.

In an example of FIG. 2, an operator A1 engaged in the distribution industry, an operator A2 engaged in the metalworking industry, and a skilled operator A3 are illustrated as operators, and a metalworking industry B1, a pharmaceutical manufacturing industry B2, a distribution industry B3, and another type of industry B4 are illustrated as business operators. These are merely examples. The operators A1 to A3 and types of industry B1 to B4 are not limitations.

In (1) recommendation of an optimal business operator and work, the job matching unit 63 finds an optimal business operator and work based on badge information included in the operator information, for example, a single digital badge and a combination of digital badges, and notifies the operator terminal 30 of the operator of the found optimal business operator and work. For example, the operator terminal 30 displays the optimal business operator and work of which the operator terminal 30 has been notified on the display unit 31. This enables the operator to grasp the optimal business operator and work.

In (2) recommendation of a succession operator, the job matching unit 63 finds a succession operator based on badge information included in the operator information, for example, a single digital badge and a combination of digital badges, and notifies the operator terminal 30 of the skilled operator A3 of the found succession operator. For example, the operator terminal 30 displays the succession operator of which the operator terminal 30 has been notified on the display unit 31. This enables the skilled operator A3 to grasp the succession operator.

In (3) search for a target badge holding operator, the business operator operates the input unit 12 of the business-operator terminal 10 to search for the target badge holding operator. In response to the search, the job matching unit 63 finds an operator holding a target badge based on operator information and the like, and notifies the business-operator terminal 10 of the found operator serving as the target badge holding operator. For example, the business-operator terminal 10 displays the target badge holding operator of which the operator terminal 30 has been notified on the display unit 11. This enables the business operator to grasp the target badge holding operator.

In (4) recommendation of an optimal operator, the job matching unit 63 finds the optimal operator based on badge information included in the operator information, for example, a single digital badge and a combination of digital badges, and notifies the business-operator terminal 10 of the optimal operator. For example, the business-operator terminal 10 displays the optimal operator of which the business-operator terminal 10 has been notified on the display unit 11. This enables the business operator to grasp the optimal operator.

### (Certification Digital Badge System)

A digital badge system for issuing a digital badge may include three types of, for example, (1) technical skill, (2) knowledge skill, and (3) general-purpose skill. For example, (1) technical skill includes a skill of actually performing work and a skill of utilizing knowledge. For example, (2) knowledge skill includes a skill of having basic knowledge in each industry and a skill of holding a qualification. For example, (3) general-purpose skill includes skills related to items such as concentration, endurance, reproducibility, and adaptability. A digital badge is issued for each of these skills. Note that a digital badge may be issued by a provider of the information processing system 1, a certified business operator different from the provider, or a business operator.

For example, when job matching is performed in the same type of industry/work, a digital badge based on the technical skill and a digital badge based on the knowledge skill may be utilized. Furthermore, when job matching is performed in different types of industries/work, a digital badge based on the general-purpose skill may be utilized first to confirm which industry easily matches.

### (Combination of Certification Digital Badges)

Examples of a pattern of a combination of certification digital badges include a combination in the same type and a combination in different types. Examples of the combination in the same type include a combination of technical skill A×technical skill B×technical skill C and a combination of general-purpose skill α×general-purpose skill β×general-purpose skill γ. Examples of the combination in different types include a combination of technical skill A×general-purpose skill γ. The combination here means a combination of individual digital badges based on respective skills. Note that the knowledge skill is effective within a range of the same type of industry/same work. The above-described combinations are merely examples and not limitations.

### <1-3. One Example of General-Purpose Skill>

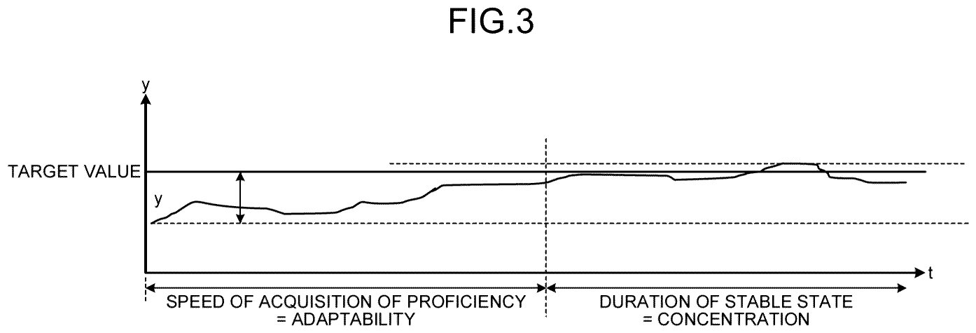

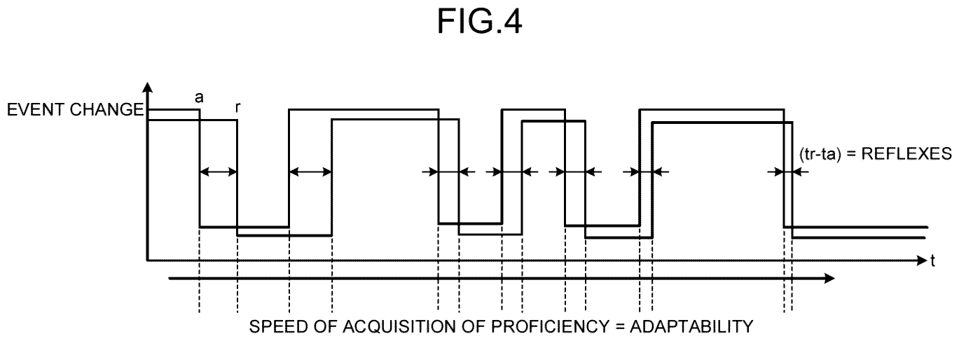

One example of the general-purpose skill according to the embodiment will be described with reference to FIGS. 3 and 4. FIGS. 3 and 4 illustrate one example of the general-purpose skill according to the embodiment. In FIGS. 3 and 4, horizontal axes represent time (t), and vertical axes represent numerical value (y) that is changed by work.

Examples of general-purpose skills that can be expressed by analysis of exercise data include concentration, endurance, reproducibility, and adaptability. The concentration is force of continuing stable work for a long time, and can be represented by (work time/standard deviation). The endurance is force for continuing work for a long time without taking a break, and can be represented by continuous work time. The reproducibility is force of repeating work with a sufficiently small difference from a work state serving as a model. The reproducibility is enhanced as a temporal change in standard deviation of difference data decreases. It can be said that the adaptability increases as a time taken from the start of work to acquisition of proficiency is shortened. The adaptability can be represented by a reciprocal of a time taken for the number of times of work per unit time to reach a sufficient level or a time taken to reach a target stable state. Such a general-purpose skill is obtained by a processing unit such as the work information analysis unit 52 and the work evaluation unit 58.

Note that the general-purpose skill may be obtained by other than the platform 50, and may be measured by, for example, the operator-side apparatus 40. Specifically, the operator-side apparatus 40 can quantify information on the reproducibility and reflexes by estimating concentration from face information and movements of the line of sight of the operator obtained by the communicator 42 and keeping an operation log of the communicator 42. For example, the operator-side apparatus 40 determines levels of sleepiness and arousal from the movements of the line of sight, and estimates concentration based on the determined levels of sleepiness and arousal.

As illustrated in FIG. 3, the speed of acquisition of proficiency determined by a time from the start of work to when the numerical value of the vertical axis reaches a target value is regarded as the adaptability (speed of acquisition of proficiency=adaptability). Furthermore, after the numerical value of the vertical axis approaches a target value (enters predetermined range) or reaches the target value, a duration of a stable state in which the numerical value is close to the target value (within predetermined range) is regarded as the concentration (duration of stable state=concentration).

Here, for example, Expression (1) below is based on FIG. 3, and relates to a task in which work is somberly advanced toward a goal.

$${\int }_{t = 0}^{X} \vert y - yt \vert dt \qquad ( Expression 1 )$$

In a case of a task in which an event change repeatedly occurs and continues to be dealt with as illustrated in FIG. 4, (tr−ta) is regarded as reflexes. Here, a represents an event change, and r represents a response thereto. The time of the reflexes (tr−ta) is shortened each time an event change occurs. This indicates that the skill of the operator to deal with an event change is improved. Thus, the speed of acquisition of proficiency determined by a time from the start of an event change to when (tr−ta) is sufficiently shortened is regarded as the adaptability (speed of acquisition of proficiency=adaptability).

Furthermore, for example, Expression (2) below is based on FIG. 4, and relates to a task in which an event changing from moment to moment is reactively dealt with.

$${\int }_{x = 1}^{∞} ( {( tr - ta )}_{X} - {( tr - ta )}_{X - 1} ) dx \qquad ( Expression 2 )$$

### <1-4. One Example of Job Matching in Different Types of Industries>

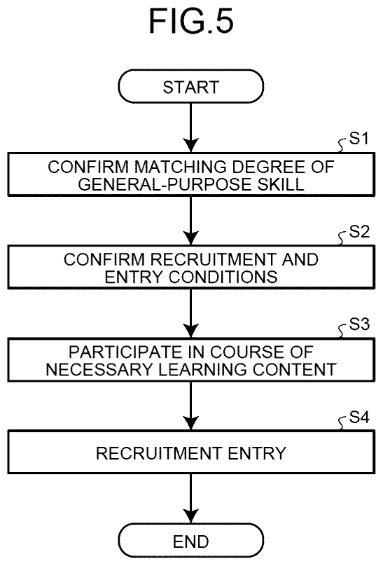

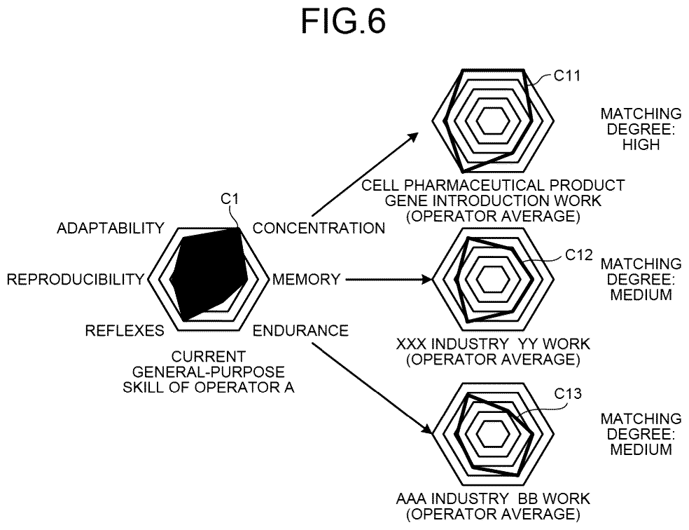

One example of job matching in different types of industries according to the embodiment will be described with reference to FIGS. 5 to 8. FIG. 5 is a flowchart illustrating one example of a flow of job matching processing in different types of industries according to the embodiment. Each of FIGS. 6 to 8 illustrates one example of job matching in different types of industries according to the embodiment.

As illustrated in FIG. 5, the operator inquires of the platform 50 to confirm a matching degree of a general-purpose skill (Step S1). The operator inquires of the platform 50 to confirm recruitment and entry conditions (Step S2). The operator participates in a course of necessary learning content on the platform 50 (Step S3). Finally, when satisfying the entry conditions, the operator makes an official entry to the platform 50 (Step S4). In Steps S1 to S4 above, for example, the operator operates the input unit 32 of the operator terminal 30 or the operation reception device 42d of the operator apparatus 40 to execute confirmation, course participation, entry, and the like to the platform 50.

Such a flow of processing is a general-purpose example. In the following assumed case, a flow until a grinding worker starts work related to a cell pharmaceutical product will be described in a specific example.

As illustrated in FIG. 5, an operator who is the grinding worker inquires of the platform 50 to confirm a “matching degree of a general-purpose skill that can be exhibited in other work” which the operator himself/herself currently has (Step S1). For example, the operator operates the input unit 32 of the operator terminal 30 to inquire of the platform 50 about a general-purpose skill and a matching degree. In response to the inquiry from the operator, the platform 50 acquires a general-purpose skill and a matching degree of the operator, and transmits the general-purpose skill and the matching degree to the operator terminal 30. For example, as illustrated in FIG. 6, the operator terminal 30 displays the general-purpose skill and the matching degree transmitted from the platform 50 on the display unit 31.

In an example of FIG. 6, a current general-purpose skill C1 of a worker A who is an operator is displayed by a spider chart. The general-purpose skill includes adaptability, concentration, memory, endurance, reproducibility, and reflexes. Furthermore, the spider chart illustrates general-purpose skills (e.g., worker average) C11 to C13 necessary for respective pieces of work (e.g., gene introduction work for cell pharmaceutical product, YY work in XXX industry, and BB work in AAA industry). Moreover, a matching degree (e.g., high, medium, and low) of the worker A to work is illustrated for each work. This enables the operator to grasp his/her general-purpose skill and matching degree to each work.

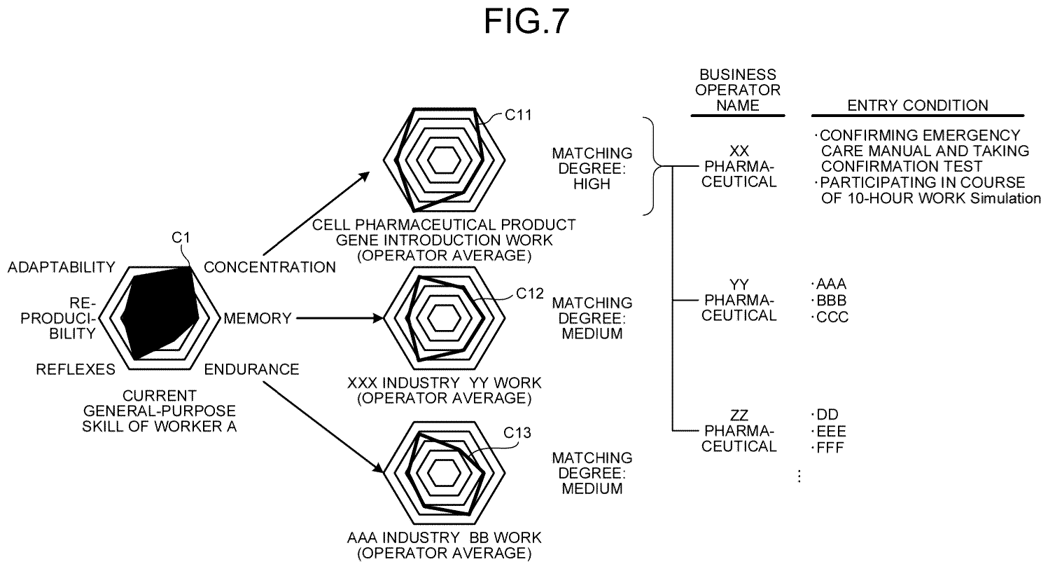

Returning to FIG. 5, the operator inquires of the platform 50 to confirm recruitment and entry conditions for beginners (Step S2). For example, the operator operates the input unit 32 of the operator terminal 30 to inquire of the platform 50 about recruitment and entry conditions for beginners. In response to the inquiry from the operator, the platform 50 acquires recruitment and entry conditions for beginners for the operator, and transmits the recruitment and the entry conditions to the operator terminal 30. For example, as illustrated in FIG. 7, the operator terminal 30 displays the recruitment and the entry conditions for beginners transmitted from the platform 50 on the display unit 31 in accordance with an image in FIG. 6.

In an example of FIG. 7, business operator names (e.g., XX Pharmaceutical, YY Pharmaceutical, and ZZ Pharmaceutical) and entry conditions in accordance with work with a high matching degree are illustrated. Examples of entry conditions in XX Pharmaceutical include confirming an emergency care manual and taking a confirmation test, and participating in a course of 10-hour work simulation. Note that the business operator names and entry conditions are merely examples, and are not particularly limited.

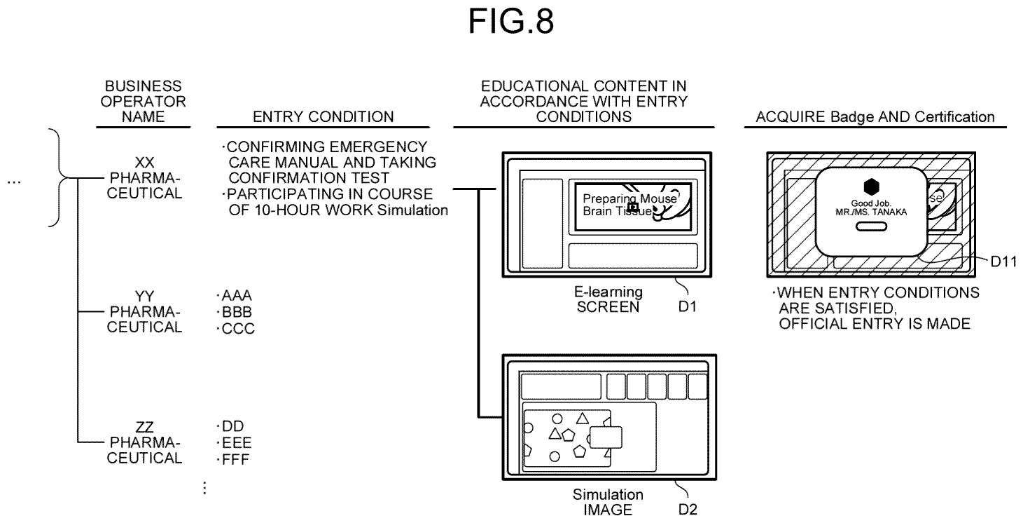

Returning to FIG. 5, the operator participates in a course of learning content in accordance with entry conditions on the platform 50, and aims to acquire a badge and a certification (Step S3). For example, the operator operates the input unit 32 of the operator terminal 30 to inquire of the platform 50 about the learning content in accordance with the entry conditions. In response to the inquiry from the operator, the platform 50 acquires learning content in accordance with the entry conditions, and transmits the learning content to the operator-side apparatus 40 corresponding to the operator terminal 30 that has made the inquiry. For example, as illustrated in FIG. 8, the operator-side apparatus 40 displays a plurality of pieces of learning content D1 and D2 transmitted from the platform 50 on the display apparatus 41 of the operator-side apparatus 40. In this case, the operator operates the operation reception device 42g of the communicator 42 to participate in courses of the respective pieces of learning content D1 and D2.

In an example of FIG. 8, respective pieces of learning content (educational content) D1 and D2 in accordance with the entry conditions are displayed. For example, when an entry condition in accordance with a business operator name (e.g., entry condition of XX Pharmaceutical) is selected, an E-learning screen is displayed as learning content D1 in accordance with the entry condition, and a simulation image is displayed as learning content D2 in accordance with the entry condition. The operator participates in a course of education (e.g., care manual and operation procedure) based on the respective pieces of learning content D1 and D2. Note that the contents of the educational content are merely examples, and are not particularly limited.

Returning to FIG. 5, finally, when satisfying the entry conditions, the operator makes an official entry to the platform 50 (Step S4). For example, as illustrated in FIG. 8, the operator-side apparatus 40 displays an image D11 indicating that the entry conditions has been satisfied on the display apparatus 41 of the operator-side apparatus 40. In the example of FIG. 8, when acquiring a badge and a certification to satisfy the entry conditions, the operator makes an official entry to an application.

Note that, although, in the above-described processing, an inquiry about recruitment for beginners is made in Step S2, this is not a limitation. For example, an inquiry about recruitment for a level other than the beginner level may be made. Furthermore, the platform 50 may skip recruitment rank input and recommend a business operator who deals with work with a high matching degree in accordance with an experience and the like so far of an applicant.

### <1-5. One Example of Digital Badge Issuing Processing>

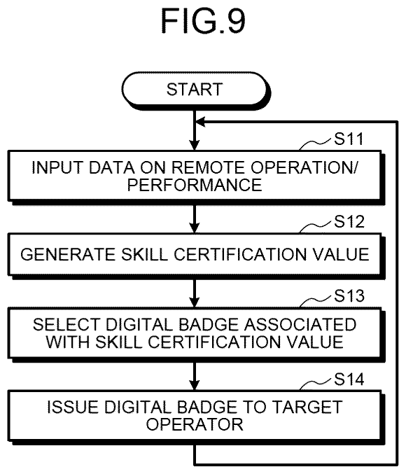

One example of digital badge issuing processing according to the embodiment will be described with reference to FIG. 9. FIG. 9 is a flowchart illustrating one example of a flow of the digital badge issuing processing according to the embodiment. The digital badge issuing processing is executed by the work evaluation unit 58 and the skill certification unit 59.

As illustrated in FIG. 9, the work evaluation unit 58 acquires data (e.g., temporal data on work and quality data) on a remote operation and quality (performance) in Step S11, and generates a skill certification value in Step S12. In Step S13, the skill certification unit 59 selects a digital badge associated with the skill certification value. Note that the digital badge is preliminarily set in accordance with the skill certification value, and the digital badge is associated with the skill certification value. In Step S14, the skill certification unit 59 issues the selected digital badge to a target operator. Such processing is repeated at predetermined timing (e.g., each time data is input or periodically), and the type of the digital badge held by the operator is updated.

<1-6. One Example of Job Matching Processing from Viewpoint of Business Operator>

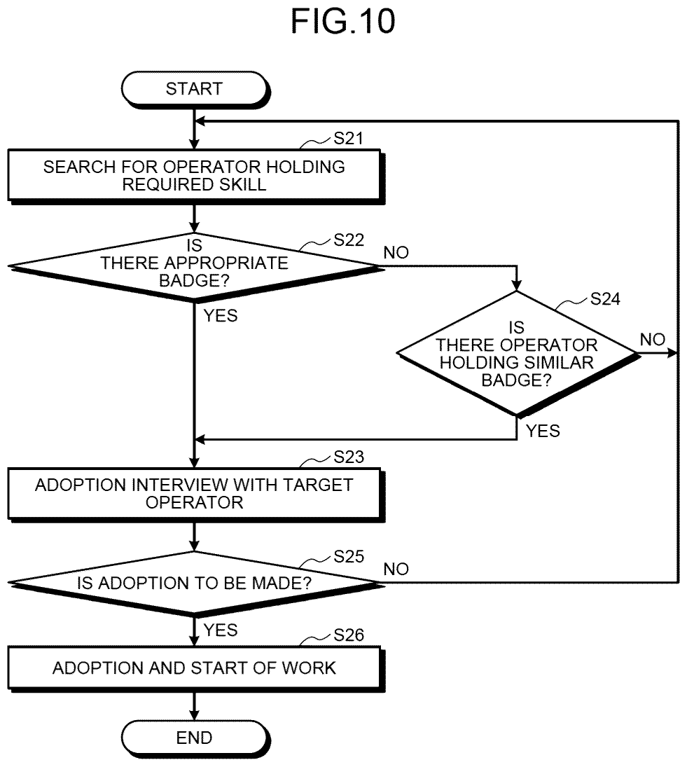

One example of job matching processing from the viewpoint of the business operator according to the embodiment will be described with reference to FIG. 10. FIG. 10 is a flowchart illustrating one example of a flow of the job matching processing from the viewpoint of the business operator according to the embodiment. The job matching unit 63 basically executes the job matching processing from the viewpoint of the business operator.

As illustrated in FIG. 10, the job matching unit 63 searches for an operator holding a required skill in response to an inquiry from the business operator in Step S21, and determines whether or not there is an appropriate badge in Step S22. When determining that there is an appropriate badge (Yes in Step S22), the job matching unit 63 performs processing related to an adoption interview with the target operator in Step S23. Examples of the processing include processing for mediating the adoption interview between the business operator and the target operator (e.g., processing of achieving videophone call and processing of exchanging contact information such as e-mail address). This causes the business operator to make an adoption interview with the target operator via the job matching unit 63. Note, however, that post-processing such as processing for mediating an adoption interview may be executed by using an external interview system or the like. In this case, the job matching unit 63 may provide information necessary for the interview to the external interview system.

In contrast, when determining that there is not an appropriate badge (No in Step S22), the job matching unit 63 determines whether or not there is an operator holding a similar badge in Step S24. When determining that there is the operator holding a similar badge (Yes in Step S24), the job matching unit 63 advances the processing to Step S23. In contrast, when determining that there is not an operator holding a similar badge (No in Step S24), the job matching unit 63 returns the processing to Step S21.

In Step S25, the job matching unit 63 determines whether or not the business operator is to make an adoption in accordance with selection of the business operator. When determining that an adoption is to be made (Yes in Step S25), the job matching unit 63 performs processing related to the adoption and the start of work in Step S26. Examples of the processing include processing of notifying the target operator of the adoption and the start of work (e.g., automatic e-mail transmission). In contrast, when determining that an adoption is not to be made (No in Step S25), the job matching unit 63 returns the processing to Step S21.

Note that, although, in the above-described processing, the operator is searched for from a skill, this is not a limitation. In addition to searching for the operator from a skill, the operator may be searched for from a badge since the badge has been acquired depending on the skill.

<1-7. One Example of Job Matching Processing from Viewpoint of Operator>

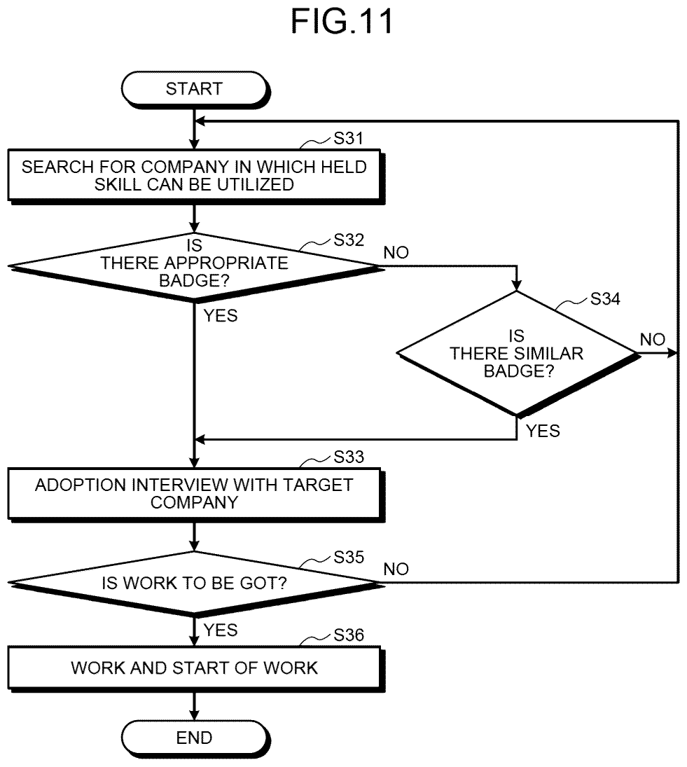

One example of job matching processing from the viewpoint of the operator according to the embodiment will be described with reference to FIG. 11. FIG. 11 is a flowchart illustrating one example of a flow of the job matching processing from the viewpoint of the operator according to the embodiment. The job matching unit 63 basically executes the job matching processing from the viewpoint of the business operator.

As illustrated in FIG. 11, the job matching unit 63 searches for a company in which a held skill can be utilized in response to an inquiry from the operator in Step S31, and determines whether or not there is an appropriate badge in Step S32. When determining that there is an appropriate badge (Yes in Step S32), the job matching unit 63 performs processing related to an adoption interview with a target company in Step S33. Examples of the processing include processing for mediating the adoption interview between the target company (business operator) and the operator (e.g., processing of achieving videophone call and processing of exchanging contact information such as e-mail address). This causes the operator to make an adoption interview with the target company via the job matching unit 63. Note, however, that, as in the above description, post-processing such as processing for mediating an adoption interview may be executed by using an external interview system or the like. In this case, the job matching unit 63 may provide information necessary for the interview to the external interview system.

In contrast, when determining that there is not an appropriate badge (No in Step S32), the job matching unit 63 determines whether or not there is a similar badge in Step S34. When determining that there is a similar badge (Yes in Step S34), the job matching unit 63 advances the processing to Step S33. In contrast, when determining that there is not a similar badge (No in Step S34), the job matching unit 63 returns the processing to Step S31.

In Step S35, the job matching unit 63 determines whether or not work is to be got in accordance with selection of the operator. When determining that work is to be got (Yes in Step S35), the job matching unit 63 performs processing related to the work and the start of work in Step S36. Examples of the processing include processing of notifying the target company of the work and the start of work (e.g., automatic e-mail transmission). In contrast, when determining that an adoption is not to be made (No in Step S35), the job matching unit 63 returns the processing to Step S31.

### <1-8. Actions/Effects>

As described above, according to the embodiment, the information processing system 1 includes: a badge management unit 60 unit that issues a digital badge in accordance with a work skill of an operator to the operator based on work information on work performed by a target to be operated (e.g., robot apparatus 22) by a remote operation of the operator; and prior information (e.g., teaching material information) on the work; and a job matching unit 63 that recommends an appropriate business operator to the operator or an appropriate operator to a business operator based on badge information on a result of issuance of the digital badge and work content information on a work content presented by the business operator. This causes an appropriate business operator to be recommended to an operator or an appropriate operator to a business operator in accordance with a work skill of the operator or the work contents of the business operator, so that appropriate job matching between a business operator and a worker can be achieved regardless of the types of industries to which the business operator and the worker belong.

Furthermore, the badge management unit 60 may issue a plurality of digital badges to the operator based on the work information and the prior information, and

the job matching unit 63 may recommend an appropriate business operator to the operator or an appropriate operator to the business operator based on a combination of the plurality of digital badges included in the badge information and the work content information. This this causes an appropriate business operator to be recommended to an operator or an appropriate operator to a business operator, so that appropriate job matching between a business operator and a worker can be reliably achieved regardless of the types of industries to which the business operator and the worker belong.

Furthermore, the plurality of digital badges of the same type may be combined. This enables an appropriate business operator to be more reliably recommended to an operator or an appropriate operator to a business operator.

Furthermore, the plurality of digital badges of different types may be combined. This enables an appropriate business operator to be more reliably recommended to an operator or an appropriate operator to a business operator.

Furthermore, the job matching unit 63 may recommend an optimal business operator to an operator. This enables an optimal business operator to be recommended to an operator, so that appropriate job matching between a business operator and a worker can be reliably achieved regardless of the types of industries to which the business operator and the worker belong.

Furthermore, the job matching unit 63 may recommend an optimal operator to a business operator. This enables an optimal operator to be recommended to a business operator, so that appropriate job matching between a business operator and a worker can be reliably achieved regardless of the types of industries to which the business operator and the worker belong.

Furthermore, the job matching unit 63 may recommend an operator holding a target digital badge to a business operator. This enables an operator holding a target digital badge to be recommended to a business operator, so that appropriate job matching between a business operator and a worker can be reliably achieved regardless of the types of industries to which the business operator and the worker belong.

Furthermore, the job matching unit 63 may recommend a succession operator, who is an appropriate operator, to a skilled operator. This enables an appropriate succession operator to be recommended to a skilled operator, so that job matching from a viewpoint of succession of technology can be achieved.

Furthermore, the job matching unit 63 may recommend an appropriate business operator to the operator or an appropriate operator to the business operator in the same type of industry or the same work. This reliably enables appropriate job matching between a business operator and a worker in the same type of industry or the same work.

Furthermore, the job matching unit 63 may recommend an appropriate business operator to the operator or an appropriate operator to the business operator between different types of industries or different types of work. This reliably enables appropriate job matching between a business operator and a worker in different types of industries or different types of work.

Furthermore, the work skill may include one and all of a technical skill, a knowledge skill, and a general-purpose skill. This causes an appropriate business operator to be recommended to an operator or an appropriate operator to a business operator, so that appropriate job matching between a business operator and a worker can be more reliably achieved regardless of the types of industries to which the business operator and the worker belong.

Furthermore, the general-purpose skill may include one or all of concentration, endurance, reproducibility, adaptability, a reflex, and memory. This enables an appropriate business operator to be more reliably recommended to an operator or an appropriate operator to a business operator.

Furthermore, the concentration may be a work time/standard deviation. As a result, the concentration can be managed as a numerical value, which enables an appropriate business operator to be more reliably recommended to an operator or an appropriate operator to a business operator.

Furthermore, the endurance may be a continuous work time. As a result, the concentration can be managed as a numerical value, which enables an appropriate business operator to be more reliably recommended to an operator or an appropriate operator to a business operator.

Furthermore, the reproducibility may be statistical data on a difference from a model. As a result, the concentration can be managed as a numerical value, which enables an appropriate business operator to be more reliably recommended to an operator or an appropriate operator to a business operator.

Furthermore, the adaptability may be a time change of the number of times of work/unit time or a time deviation of distribution. As a result, the concentration can be managed as a numerical value, which enables an appropriate business operator to be more reliably recommended to an operator or an appropriate operator to a business operator.

Furthermore, the information processing system 1 further includes a work evaluation unit 58 that evaluates the work skill as a skill certification value based on the work information and the prior information, and the badge management unit 60 may issue the digital badge to the operator based on an evaluation result information on an evaluation result of the work skill. As a result, a digital badge can be more appropriately issued, which enables an appropriate business operator to be more reliably recommended to an operator or an appropriate operator to a business operator.

Furthermore, the information processing system 1 further includes a skill certification unit 59 that certifies a skill of the operator based on the evaluation result information, and the badge management unit 60 may issue the digital badge to the operator based on certification result information on a certification result of a skill of the operator. As a result, a digital badge can be more appropriately issued, which enables an appropriate business operator to be more reliably recommended to an operator or an appropriate operator to a business operator.

### 2. Other Embodiments

The processing according to the above-described embodiment (or variations) may be conducted in various different forms (variations) other than the above-described embodiment. For example, among pieces of processing described in the above-described embodiment, all or part of the processing described as being performed automatically can be performed manually, or all or part of the processing described as being performed manually can be performed automatically by a known method. In addition, the processing procedures, specific names, and information including various pieces of data and parameters in the above document and drawings can be optionally changed unless otherwise specified. For example, various pieces of information in each figure are not limited to the illustrated information.

Furthermore, each component of each illustrated apparatus is functional and conceptual, and does not necessarily need to be physically configured as illustrated. That is, the specific form of distribution/integration of each apparatus is not limited to the illustrated one, and all or part of the device can be configured in a functionally or physically distributed/integrated manner in any unit in accordance with various loads and use situations.

Furthermore, the above-described embodiment (or variations) can be appropriately combined as long as the processing contents do not contradict each other. Furthermore, the effects described in the present specification are merely examples and not limitations. Other effects may be exhibited.

### 3. Configuration Example of Hardware

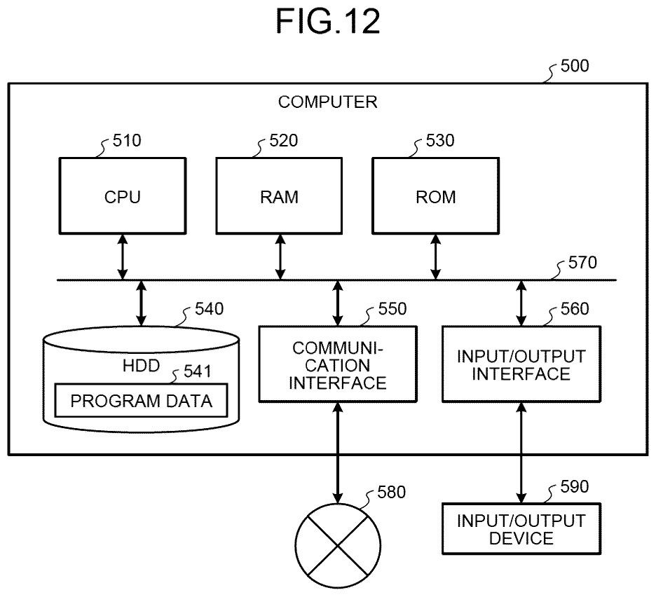

A specific hardware configuration example of an information device included in the business-operator-side terminal 10, the business-operator-side apparatus 20, the operator-side terminal 30, the operator-side apparatus 40, and the platform 50 according to the above-described embodiment (or variations) will be described. The information device may be implemented by, for example, a computer 500 having a configuration as illustrated in FIG. 12. FIG. 12 illustrates a configuration example of hardware that implements the functions of the information device.

As illustrated in FIG. 12, the computer 500 includes a CPU 510, a RAM 520, a read only memory (ROM) 530, a hard disk drive (HDD) 540, a communication interface 550, and an input/output interface 560. Units of the computer 500 are connected by a bus 570.

The CPU 510 operates based on a program stored in the ROM 530 or the HDD 540, and controls each unit. For example, the CPU 510 develops the program stored in the ROM 530 or the HDD 540 on the RAM 520, and executes processing corresponding to various programs.

The ROM 530 stores a boot program such as a basic input output system (BIOS) executed by the CPU 510 at the time when the computer 500 is activated, a program depending on the hardware of the computer 500, and the like.

The HDD 540 is a computer-readable recording medium that non-transiently records a program executed by the CPU 510, data used by the program, and the like. Specifically, the HDD 540 is a recording medium that records an information processing program according to the present disclosure. The information processing program is one example of program data 541.

The communication interface 550 is used for connecting the computer 500 with an external network 580 (e.g., Internet). For example, the CPU 510 receives data from another device and transmits data generated by the CPU 510 to another device via the communication interface 550.

The input/output interface 560 connects an input/output device 590 with the computer 500. For example, the CPU 510 receives data from an input device such as a keyboard and a mouse via the input/output interface 560. Furthermore, the CPU 510 transmits data to an output device such as a display, a speaker, and a printer via the input/output interface 560.

Note that, the input/output interface 560 may function as a medium interface that reads a program and the like recorded in a predetermined recording medium. Examples of the medium includes an optical recording medium such as a digital versatile disc (DVD) and a phase change rewritable disk (PD), a magneto-optical recording medium such as a magneto-optical disk (MO), a tape medium, a magnetic recording medium, and a semiconductor memory.

Here, for example, when the computer 500 functions as an information device, the CPU 510 of the computer 500 implements all or a part of the functions of each unit according to the embodiment (or variations) by executing an information processing program loaded on the RAM 520. Furthermore, the HDD 540 stores an information processing program according to the present disclosure and data. Note that the CPU 510 reads the program data 541 from the HDD 540 and executes the program data 541. In another example, the CPU 510 may acquire these programs from another apparatus via the external network 580.

### 4. Appendix

Note that the present technology can also have the configurations as follows.

(1)

An information processing system comprising:
a badge management unit that issues a digital badge in accordance with a work skill of an operator to the operator based on work information on work performed by a target to be operated by a remote operation of the operator and prior information on the work; and
a job matching unit that recommends an appropriate business operator to the operator or an appropriate operator to a business operator based on badge information on a result of issuance of the digital badge and work content information on a work content presented by the business operator.
   (2)

The information processing system according to (1),
wherein the badge management unit issues a plurality of digital badges to the operator based on the work information and the prior information, and
the job matching unit recommends an appropriate business operator to the operator or an appropriate operator to the business operator based on a combination of the plurality of digital badges included in the badge information and the work content information.
   (3)

The information processing system according to (2),
wherein the plurality of digital badges of a same type is combined.
   (4)

The information processing system according to (2),
wherein the plurality of digital badges of different types is combined.
   (5)

The information processing system according to any one of (1) to (4),
wherein the job matching unit recommends an optimal business operator to the operator.
   (6)

The information processing system according to any one of (1) to (5),
wherein the job matching unit recommends an optimal operator to the business operator.
   (7)

The information processing system according to any one of (1) to (6),
wherein the job matching unit recommends an operator holding a target digital badge to the business operator.
   (8)

The information processing system according to any one of (1) to (7),
wherein the job matching unit recommends a succession operator, who is the appropriate operator, to a skilled operator.
   (9)

The information processing system according to any one of (1) to (8),
wherein the job matching unit recommends an appropriate business operator to the operator or an appropriate operator to the business operator in a same type of industry or a same work.
   (10)

The information processing system according to any one of (1) to (8),
wherein the job matching unit recommends an appropriate business operator to the operator or an appropriate operator to the business operator between different types of industries or different types of work.
   (11)

The information processing system according to any one of (1) to (10),
wherein the work skill includes one and all of a technical skill, a knowledge skill, and a general-purpose skill.
   (12)

The information processing system according to (11),
wherein the general-purpose skill includes one or all of concentration, endurance, reproducibility, adaptability, a reflex, and memory.
   (13)

The information processing system according to (12),
wherein the concentration is a work time/standard deviation.
   (14)

The information processing system according to (12) or (13),
wherein the endurance is a continuous work time.
   (15)

The information processing system according to any one of (12) to (14),
wherein the reproducibility is statistical data on a difference from a model.
   (16)

The information processing system according to any one of (12) to (15),
wherein the adaptability is a time change of a number of times of work/unit time or a time deviation of distribution.
   (17)

The information processing system according to any one of (1) to (16), further comprising
a work evaluation unit that evaluates the work skill as a skill certification value based on the work information and the prior information,
wherein the badge management unit issues the digital badge to the operator based on an evaluation result information on an evaluation result of the work skill.
   (18)

The information processing system according to (17), further comprising
a skill certification unit that certifies a skill of the operator based on the evaluation result information,
wherein the badge management unit issues the digital badge to the operator based on certification result information on a certification result of a skill of the operator.
   (19)

An information processing apparatus comprising:
a badge management unit that issues a digital badge in accordance with a work skill of an operator to the operator based on work information on work performed by a target to be operated by a remote operation of the operator and prior information on the work; and
a job matching unit that recommends an appropriate business operator to the operator or an appropriate operator to a business operator based on badge information on a result of issuance of the digital badge and work content information on a work content presented by the business operator.
   (20)

An information processing method comprising:
issuing a digital badge in accordance with a work skill of an operator to the operator based on work information on work performed by a target to be operated by a remote operation of the operator and prior information on the work; and
recommending an appropriate business operator to the operator or an appropriate operator to a business operator based on badge information on a result of issuance of the digital badge and work content information on a work content presented by the business operator.
   (21)

The information processing apparatus including a component of the information processing system according to any one of (1) to (18).

(22)

The information processing method using the information processing system according to any one of (1) to (18).

### REFERENCE SIGNS LIST

1 INFORMATION PROCESSING SYSTEM
10 BUSINESS-OPERATOR-SIDE TERMINAL
11 DISPLAY UNIT
12 INPUT UNIT
13 COMMUNICATION UNIT
20 BUSINESS-OPERATOR-SIDE APPARATUS
21 STATUS MONITORING APPARATUS
21a IMAGING UNIT
21b IMAGING UNIT
22 ROBOT APPARATUS
22a COMMUNICATION UNIT
22b ARM MANIPULATOR
22c VARIOUS SENSORS
22d MOVING UNIT
22e CONTROL UNIT
23 ROBOT CONTROLLER
23a COMMUNICATION UNIT
23b VIDEO PROCESSING UNIT
23c CONTROL INFORMATION PROCESSING UNIT
23d ROBOT CONTROL MODEL
30 OPERATOR-SIDE TERMINAL
31 DISPLAY UNIT
32 INPUT UNIT
33 COMMUNICATION UNIT
40 OPERATOR-SIDE APPARATUS
41 DISPLAY APPARATUS
41a DISPLAY UNIT
42 COMMUNICATOR
42a COMMUNICATION UNIT
42b TACTILE SENSE/FORCE SENSE PRESENTATION UNIT
42c OPERATION AUTHENTICATION UNIT
42d OPERATION RECEPTION DEVICE
42e CONTROL UNIT
43 ROBOT CONTROLLER
43a COMMUNICATION UNIT
43b VIDEO PROCESSING UNIT
43c CONTROL INFORMATION PROCESSING UNIT
43d ASSIST INFORMATION GENERATION MODEL
50 PLATFORM
51 COMMUNICATION UNIT
52 WORK INFORMATION ANALYSIS UNIT
53 DATA ANALYSIS UNIT
54 DEVICE LOG DB
55 VIDEO ANALYSIS UNIT
56 VIDEO DB
57 TEACHING MATERIAL PROVISION UNIT
58 WORK EVALUATION UNIT
59 SKILL CERTIFICATION UNIT
60 BADGE MANAGEMENT UNIT
61 OPERATOR DB
62 REQUESTER DB
63 JOB MATCHING UNIT
N NETWORK

1. An information processing system comprising:
a badge management unit that issues a digital badge in accordance with a work skill of an operator to the operator based on work information on work performed by a target to be operated by a remote operation of the operator and prior information on the work; and
a job matching unit that recommends an appropriate business operator to the operator or an appropriate operator to a business operator based on badge information on a result of issuance of the digital badge and work content information on a work content presented by the business operator.

2. The information processing system according to claim 1,
wherein the badge management unit issues a plurality of digital badges to the operator based on the work information and the prior information, and
the job matching unit recommends an appropriate business operator to the operator or an appropriate operator to the business operator based on a combination of the plurality of digital badges included in the badge information and the work content information.

3. The information processing system according to claim 2,
wherein the plurality of digital badges of a same type is combined.

4. The information processing system according to claim 2,
wherein the plurality of digital badges of different types is combined.

5. The information processing system according to claim 1,
wherein the job matching unit recommends an optimal business operator to the operator.

6. The information processing system according to claim 1,
wherein the job matching unit recommends an optimal operator to the business operator.

7. The information processing system according to claim 1,
wherein the job matching unit recommends an operator holding a target digital badge to the business operator.

8. The information processing system according to claim 1,
wherein the job matching unit recommends a succession operator, who is the appropriate operator, to a skilled operator.

9. The information processing system according to claim 1,
wherein the job matching unit recommends an appropriate business operator to the operator or an appropriate operator to the business operator in a same type of industry or a same work.

10. The information processing system according to claim 1,
wherein the job matching unit recommends an appropriate business operator to the operator or an appropriate operator to the business operator between different types of industries or different types of work.

11. The information processing system according to claim 1,
wherein the work skill includes one and all of a technical skill, a knowledge skill, and a general-purpose skill.

12. The information processing system according to claim 11,
wherein the general-purpose skill includes one or all of concentration, endurance, reproducibility, adaptability, a reflex, and memory.

13. The information processing system according to claim 12,
wherein the concentration is a work time/standard deviation.

14. The information processing system according to claim 12,
wherein the endurance is a continuous work time.

15. The information processing system according to claim 12,
wherein the reproducibility is statistical data on a difference from a model.

16. The information processing system according to claim 12,
wherein the adaptability is a time change of a number of times of work/unit time or a time deviation of distribution.

17. The information processing system according to claim 1, further comprising
a work evaluation unit that evaluates the work skill as a skill certification value based on the work information and the prior information,
wherein the badge management unit issues the digital badge to the operator based on an evaluation result information on an evaluation result of the work skill.

18. The information processing system according to claim 17, further comprising
a skill certification unit that certifies a skill of the operator based on the evaluation result information,
wherein the badge management unit issues the digital badge to the operator based on certification result information on a certification result of a skill of the operator.

19. An information processing apparatus comprising:
a badge management unit that issues a digital badge in accordance with a work skill of an operator to the operator based on work information on work performed by a target to be operated by a remote operation of the operator and prior information on the work; and
a job matching unit that recommends an appropriate business operator to the operator or an appropriate operator to a business operator based on badge information on a result of issuance of the digital badge and work content information on a work content presented by the business operator.

20. An information processing method comprising:
issuing a digital badge in accordance with a work skill of an operator to the operator based on work information on work performed by a target to be operated by a remote operation of the operator and prior information on the work; and
recommending an appropriate business operator to the operator or an appropriate operator to a business operator based on badge information on a result of issuance of the digital badge and work content information on a work content presented by the business operator.
